(19) United States
(12) Patent Application Publication
(10) Pub. No.: US 2025/0041955 A1
(43) Pub. Date: Feb. 6, 2025

(54) SAWDUST DISCHARGE GUIDING DEVICE OF CARPENTER CIRCULAR SAW MACHINE

(71) Applicant: Hsi-Hui YU, Taichung City (TW)

(72) Inventor: Hsi-Hui YU, Taichung City (TW)

(21) Appl. No.: 18/494,787

(22) Filed: Oct. 26, 2023

(30) Foreign Application Priority Data
Aug. 1, 2023 (TW) 112208094

(51) Int. Cl. B23D 59/00

(52) U.S. Cl. CPC B23D 59/006

(57) ABSTRACT

A sawdust discharge guiding device of a carpenter circular saw machine is provided, including a dust shielding cover including a fixed cover body including first and second end walls and first and second lateral walls having bottoms to which a dust discharge portion having a dust discharge opening is connected; a movable shield plate including a pivot through-hole; a pivot assembly pivotally connected between a pivot aperture formed in the fixed cover body and the pivot through-hole of the movable shield plate to allow the movable shield plate to rotate about the pivot assembly; and a torsion spring having a middle through which the pivot assembly penetrate and having one end supported on the first lateral wall of the fixed cover body and an opposite end supported on the movable shield plate to provide a biasing force for upward rotation to the movable shield plate.

### BACKGROUND OF THE INVENTION

### (a) Technical Field of the Invention

The present invention relates generally to a circular saw machine for woodworking, and more particularly to a sawdust discharge guiding device of a carpenter circular saw machine.

### (b) Description of the Prior Art

As shown in FIGS. 1-3, a traditional woodworking circular saw machine generally includes a chassis 1, two suspension seats 2, a saw blade holding seat 3, a drive motor 6, and a platform 4. The two suspension seats 2 are arranged at two sides of the chassis 1 at locations opposite to each other. The saw blade holding seat 3 is provided for mounting a circular saw blade 5. The saw blade holding seat 3 is connected between the two suspension seats 2 and is operated by applying a force thereto to swing and incline leftwards and rightwards. The platform 4 is arranged on the chassis 1 and is formed with a through opening 6 through which the circular saw blade 5 extends out. However, when the circular saw blade 5 is operated to cut a timber, sawdust is generated. The sawdust, if allowed to scatter around, may cause pollution to the surroundings and may get accumulated on various components of the woodworking circular saw machine, making cleaning difficult, operation unsmooth, and components damaged.

Thus, a modern woodworking circular saw machine is additionally equipped with a dust discharge guiding device 7 arranged on the saw blade holding seat 3. The dust discharge guiding device 7 comprises a dust-blocking shield 8 and a discharge tube 9 having one end connected to and communicating with the dust-blocking shield 8. An opposite end of the discharge tube 9 is connected to a suction pump (not shown) that generates a suction force. The dust-blocking shield 8 is mounted to the saw blade holding seat 3, such that except a portion of the circular saw blade 5 that projects out of the platform 4, the remaining portion is covered by the dust-blocking shield 8 so as to block sawdust in the interior of the dust-blocking shield 8, and then, the sawdust in the interior of the dust-blocking shield 8 is drawn by the suction force of the suction pump to move through the discharge tube 9 to be discharged out and collected.

However, in addition to adjustment in respect of height, the circular saw blade 5 and the saw blade holding seat 3 may also need to swing and incline leftwards and rightwards, and as such, the dust-blocking shield 8 cannot be arranged to completely cover the underside of the platform 4, and a gap must be provided between the dust-blocking shield 8 and the platform 4 to prevent the dust-blocking shield 8 that swings sideways with the leftwards or rightwards swinging of the saw blade holding seat 3 from interfering with and hitting the platform. Consequently, sawdust generated by a cutting operation may be readily blown out through the gap between the dust-blocking shield 8 and the platform 4 to scatter around, and this still results in pollution to the surroundings.

Further, the dust-blocking shield 8 including blocking walls at both a near saw point A (the near saw point referring to a location close to where the circular saw blade saws a wood board) and a far saw point B (the far saw point referring to a location far away from where the circular saw blade saws the wood board) of the circular saw blade 5 to block sawdust. However, the discharge tube 9 is arranged at a location that is even further than the far saw point. Consequently, before the sawdust that falls into the dust-blocking shield 8 is sucked away by the discharge tube 9, a portion of the sawdust that gets contact with the blocking walls of the dust-blocking shield 8 may be driven by an airflow generated by the high-speed rotation of the circular saw blade 5 to move upward and may then be blown out through the through opening 41 of the platform 4 to pollute the surroundings or get attached to the body of an operator.

### SUMMARY OF THE INVENTION

In view of the above, the present invention is made to overcome the deficiency of a prior art carpenter circular saw machine that sawdust is easily blown out to get scattering around the surroundings and the sawdust may get accumulated on the components, making cleaning difficult, operation unsmooth, and components damaged.

An objective of the present invention is to provide a sawdust discharge guiding device of a carpenter circular saw machine, which helps reduce occurrence of sawdust being blown to the outside.

Another objective of the present invention is to provide a sawdust discharge guiding device of a carpenter circular saw machine, which helps reduce occurrence of accumulation of sawdust on components.

Thus, the present invention provides a sawdust discharge guiding device of a carpenter circular saw machine, comprising: a dust shielding cover, which comprises a fixed cover body, a movable shield plate, a pivot assembly, and a torsion spring; the fixed cover body comprises a first end wall, a first lateral wall having one side perpendicularly connected to one side of the first end wall, a second lateral wall having one side connected to an opposite side of the first end wall, a second end wall connected between an opposite side of the first lateral wall and an opposite side of the second lateral wall, the second end wall having a height lower than a height of the first end wall, and a dust discharge portion connected among bottoms of the first end wall, the first lateral wall, the second lateral wall and the second end wall, the dust discharge portion and the fixed cover body defining therebetween an angle, the dust discharge portion comprising communicating between inside and outside, a top portion among the first end wall, the first lateral wall, the second lateral wall, and the second end wall being made hollow, a pivot aperture being formed in a top of the first end wall; the movable shield plate comprises a pivot through-hole; the pivot assembly penetrates through and pivotally connects between the pivot aperture of the fixed cover body and the pivot through-hole of the movable shield plate, so that the movable shield plate is rotatable about an axis defined by the pivot assembly; the torsion spring comprises a middle portion through which the pivot assembly penetrates and has one end supported on the first lateral wall of the fixed cover body and an opposite end supported on the movable shield plate, such that the torsion spring provides a preloading spring force to the movable shield plate for upward rotation, and as such, occurrence of sawdust being blown out is prevented.

### BRIEF DESCRIPTION OF THE DRAWINGS

FIG. 1 is an exploded view of a prior art woodworking circular saw machine.

FIG. 2 is an exploded view of the prior art woodworking circular saw machine.

FIG. 3 is a cross-sectional view of the prior art woodworking circular saw machine in an assembled form.

FIG. 4 is an exploded view showing a preferred embodiment of the present invention.

FIG. 5 is an exploded view showing a portion of the embodiment of FIG. 4.

FIG. 6 is an exploded view, taken from a different angle, showing the portion of the embodiment of FIG. 4.

FIGS. 7-10 are schematic views showing a condition of use of the embodiment of FIG. 4.

FIG. 11 is a perspective view showing another embodiment of the present invention.

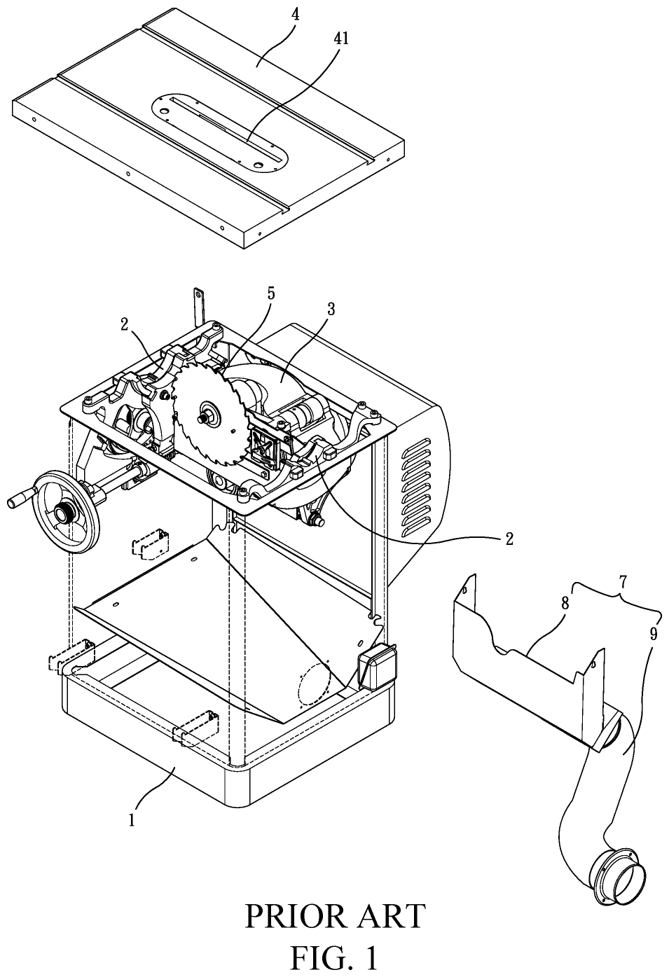

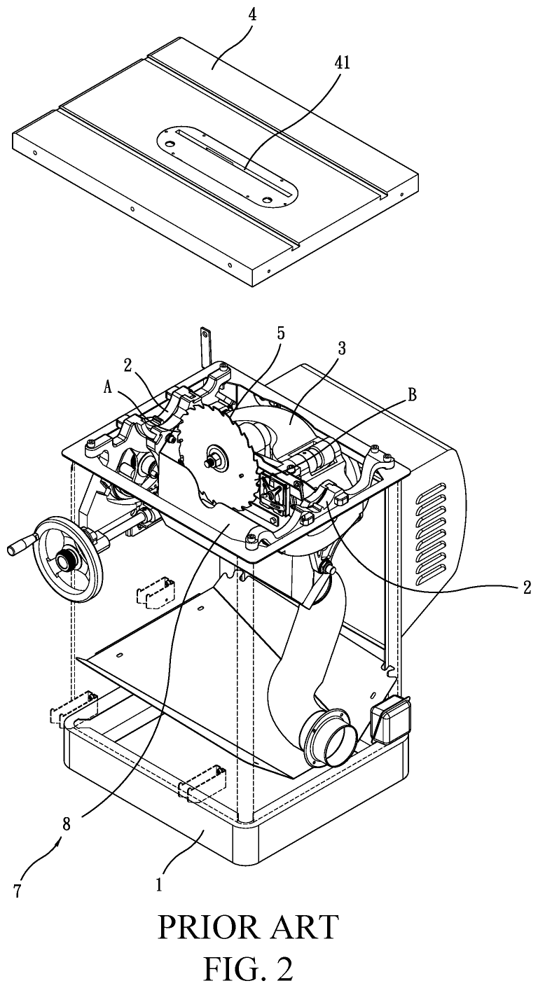

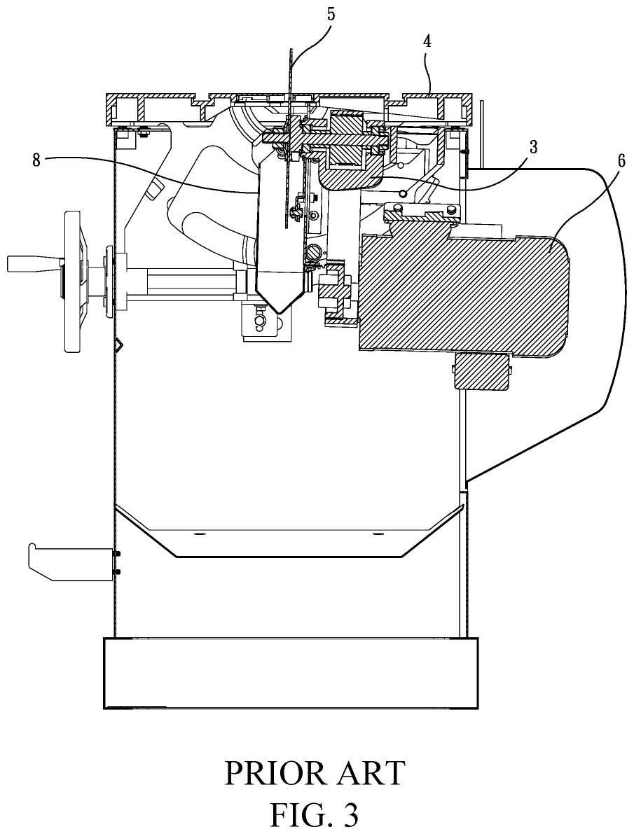

### DETAILED DESCRIPTION OF THE PREFERRED EMBODIMENTS

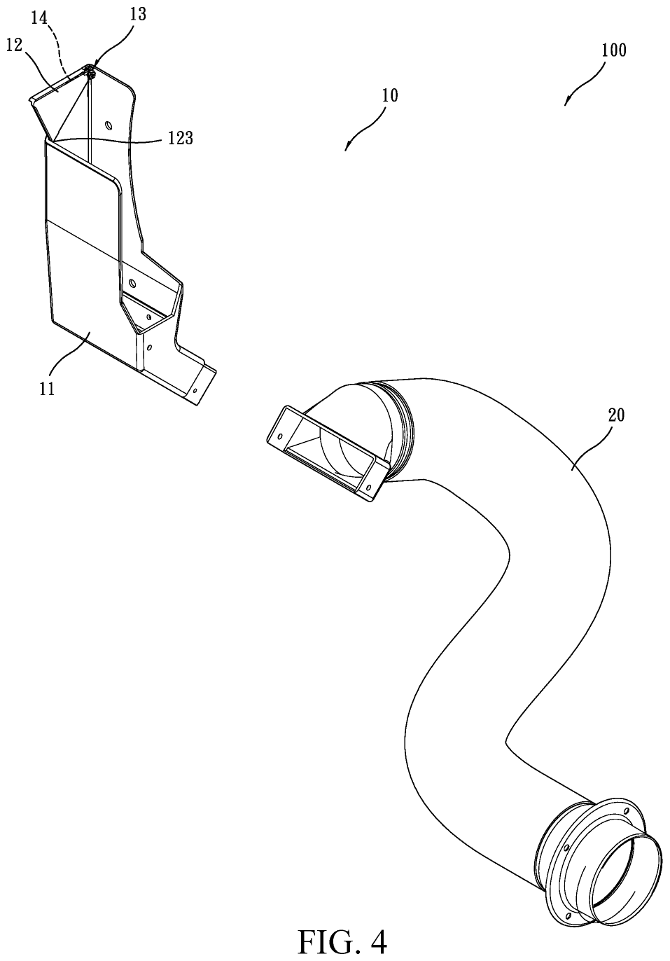

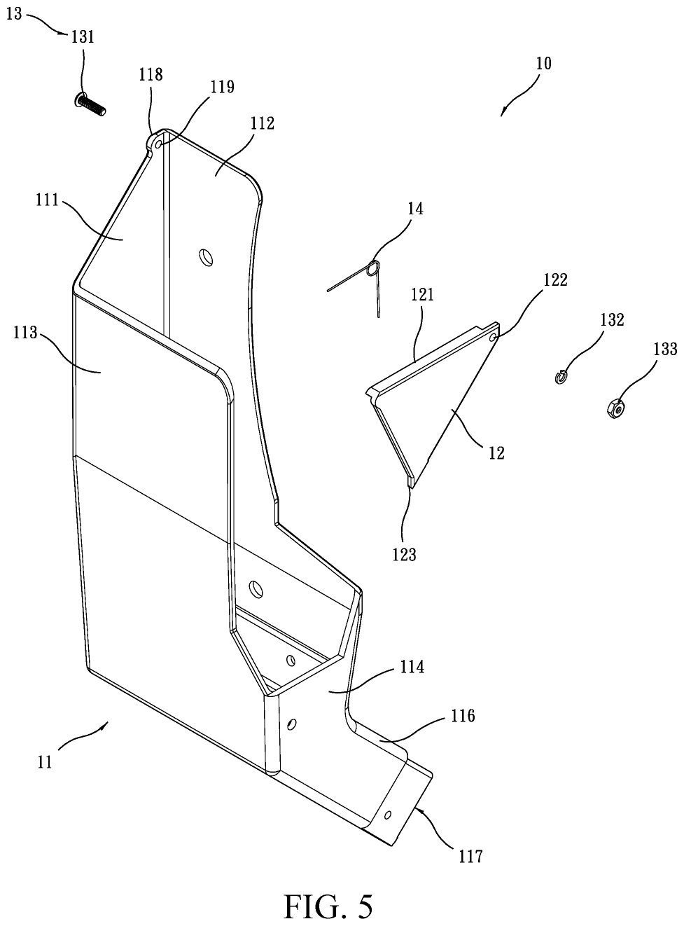

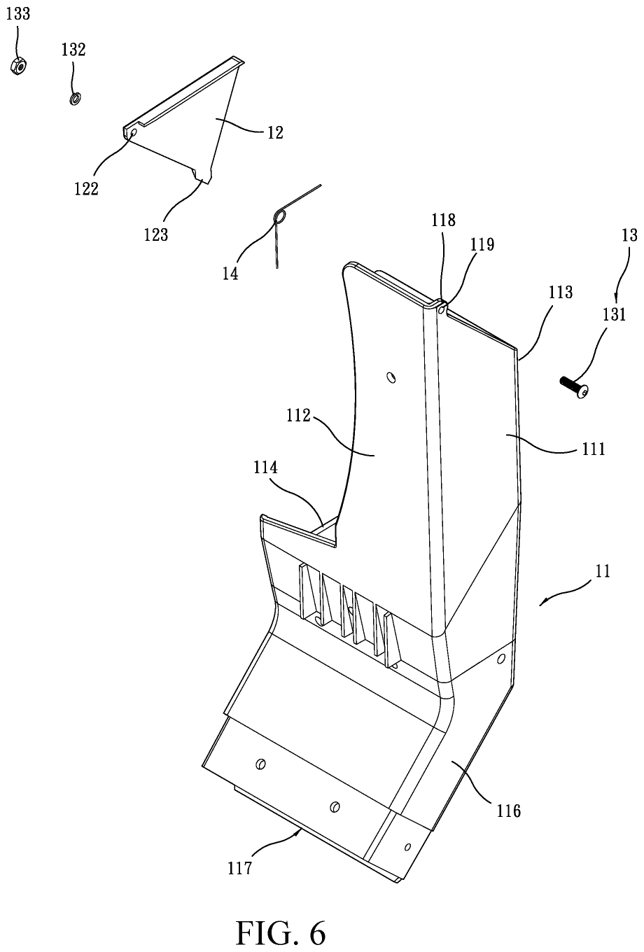

Referring to FIGS. 4-10, the present invention provides, in a preferred embodiment, a sawdust discharge guiding device 100 of a carpenter circular saw machine, which mainly comprises a dust shielding cover 10 and a dust discharge tube 20.

Referring to FIGS. 4-6, the dust shielding cover 10 comprises a fixed cover body 11, a movable shield plate 12, a pivot assembly 13, and a torsion spring 14. The fixed cover body 11 comprises a first end wall 111, a first lateral wall 112 having one side perpendicularly connected to one side of the first end wall 111, a second lateral wall 113 having one side connected to an opposite side of the first end wall 111, a second end wall 114 connected between an opposite side of the first lateral wall 112 and an opposite side of the second lateral wall 113, the second end wall 114 having a height smaller than a height of the first end wall 111, a dust discharge portion 116 connected between bottoms of the first end wall 111, the first lateral wall 112, the second lateral wall 113, and the second end wall 114. The dust discharge portion 116 and the fixed cover body 11 define an angle, which is an obtuse angle, therebetween. The dust discharge portion 116 comprises a dust discharge opening 117 that communicates between inside and outside and is thus in communication with the fixed body 11. A top portion among the first end wall 111, the first lateral wall 112, the second lateral wall 113, and the second end wall 114 is made hollow. The first end wall 111 is provided, on a top thereof, with a lug 118 at a location adjacent to the first lateral wall 112. The lug 118 is formed with a pivot aperture 119. The movable shield plate 12 is a plate of a generally triangular shape, which is protruded from one side to form a contact flange 121. The movable shield plate 12 is formed, in a corner thereof, with a pivot through-hole 122, and the movable shield plate 12 is extended from another corner thereof to form a projection that form a contact block 123. The pivot assembly 13 comprises a bolt 131, a washer 132, and a nut 133. The bolt 131 penetrates through the pivot aperture 119 of the fixed cover body 11, the pivot through-hole 122 of the movable shield plate 12, and the washer 132, and the nut 133 and the bolt 131 are screwed to each other so that the movable shield plate 12 is constrained to be only rotatable about an axis defined by the bolt 131 of the pivot assembly 13. The torsion spring 14 includes a middle portion through which the bolt 131 of the pivot assembly 13 penetrates and has one end supported on the first lateral wall 112 of the fixed cover body 11 and an opposite end supported on the contact flange 121 of the movable shield plate 12, such that the torsion spring 14 provides a preloading spring force to the movable shield plate 12 for upward rotation.

Referring to FIG. 4, the dust discharge tube 20 has one end connected to the dust discharge portion 116 of the fixed cover body 11 of the dust shielding cover 10 to have the dust discharge tube 20 communicating with an interior of the dust shielding cover 10, and is twistable for deformation as being acted upon by a force.

Thus, the above provides an introduction to components of the sawdust discharge guiding device 100 of a carpenter circular saw machine according to a preferred embodiment of the present invention, as well as assembly thereof, and in the following, features of operation will be provided below.

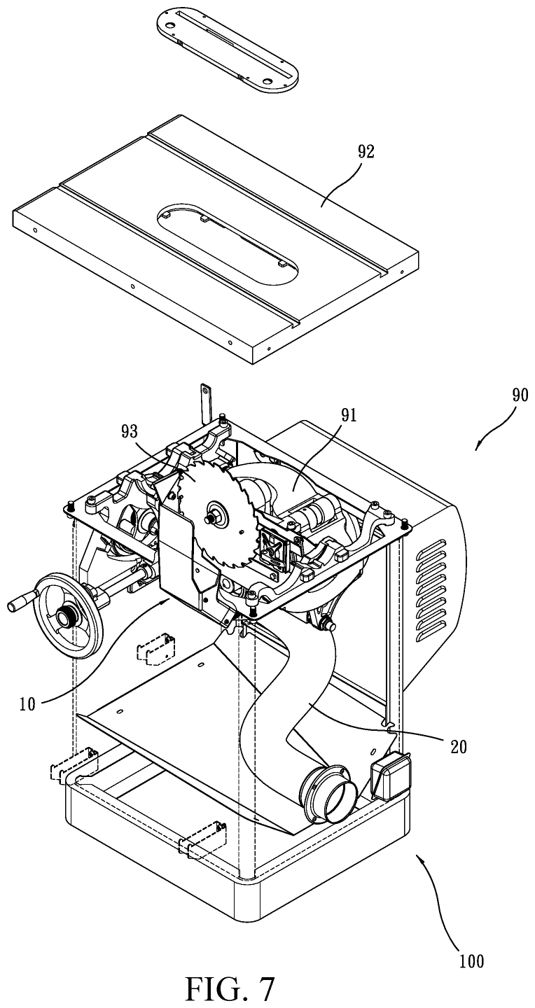

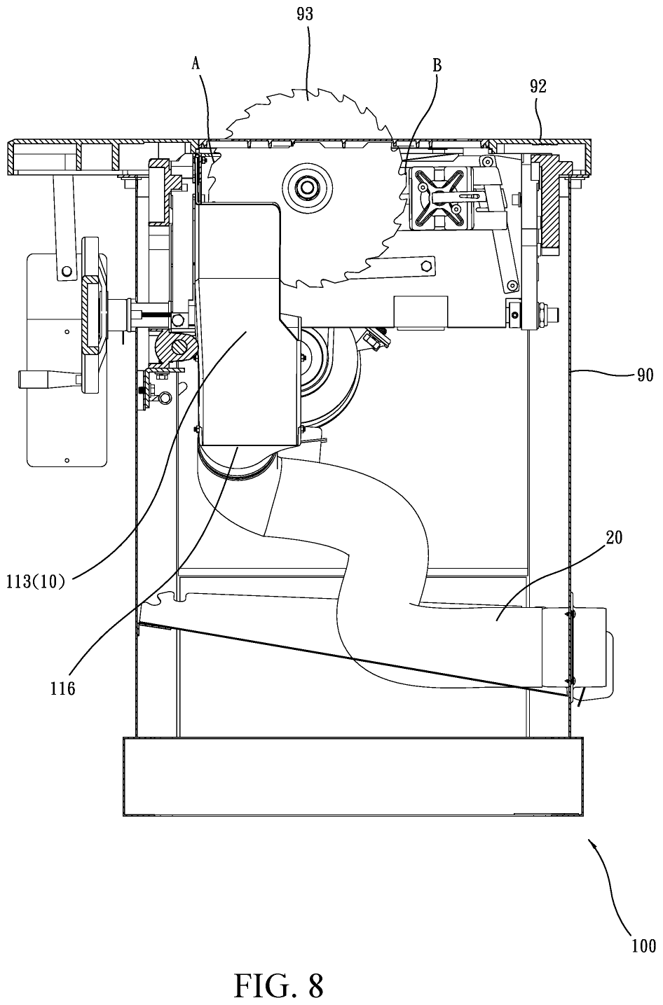

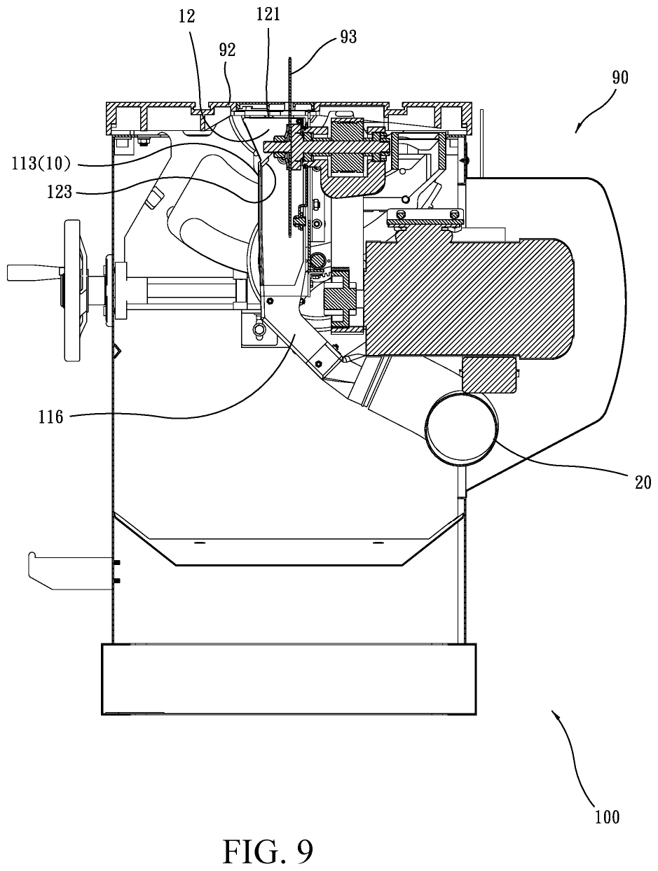

Firstly, the present invention is made such that the first lateral wall 111 of the fixed cover body 11 of the dust shielding cover 10 is fixedly connectable to a circular saw blade mounting seat 91 of a carpenter circular saw machine 90 (as shown in FIG. 7), so that a neighbor area of a near saw point A (the near saw point referring to a location where a wood board is being sawn by the circular saw blade) of the circular saw blade 93 that is located under the platform 92 is located inside the fixed cover body 11, and a far saw point B (the far saw point referring to a location that is far away from where the wood board is being sawn by the circular saw blade) is located outside the fixed cover body 11 (as shown in FIG. 8). Further, when the circular saw blade 93 is in a vertical condition, the contact block 123 of the movable shield plate 12 is set in contact with an inside surface of the second lateral wall 113, while the contact flange 121 is positioned against an undersurface of the platform 92 to be kept in a horizontal condition (as shown in FIG. 9), so that when the circular saw blade 93 is being operated to saw a workpiece, sawdust generated by the operation is driven by an airflow that is generated by high-speed rotation of the circular saw blade 93 to move into the interior of the dust shielding cover 10 and is blocked by the movable shield plate 12, the first end wall 111, the first lateral wall 112, and the second lateral wall 113 to thus fall into the dust discharge portion 116. In the present invention, the dust discharge tube 20 is arranged at a location corresponding to the near saw point A, so that the sawdust can be efficiently drawn in to be then discharged and collected. Since the sawdust is completely sucked, at first time, into the dust discharge tube 20 to be discharged therefrom, there is no the sawdust to be moved out by an upward airflow induced by the high-speed rotation of the circular saw blade 93 at the far saw point B.

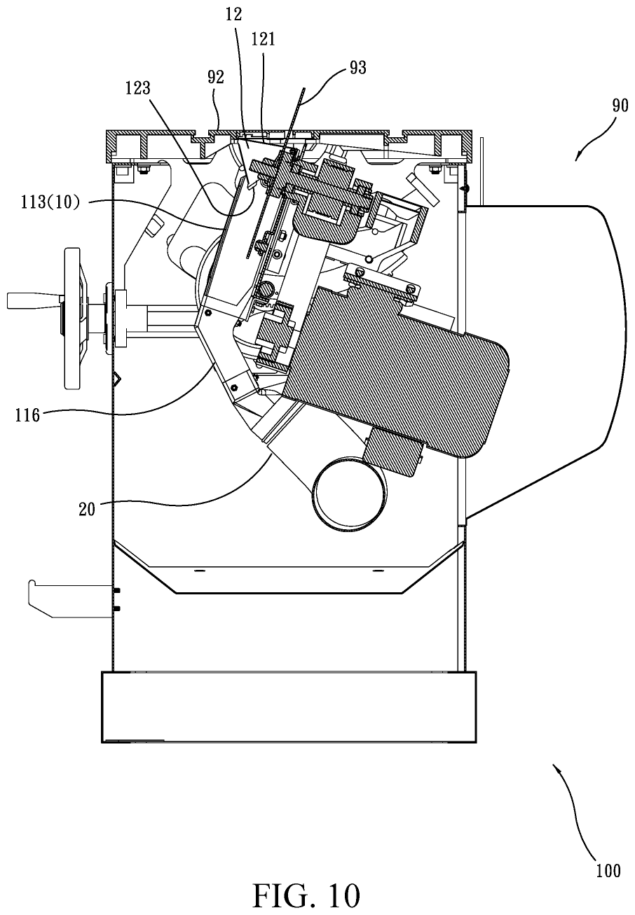

When the circular saw blade mounting seat 91 is operated to drive the circular saw blade 93 to sideway swing to become an inclined condition, due to the movable shield plate 12 being biased by the torsion spring 14, the contact block 123 is kept in contact with the inside surface of the second lateral wall 113 and is also caused to sideway swing to incline, in an upward direction, to an angle, until the movable shield plate 12 is blocked by the platform 92, but is still set by the spring force of the torsion spring 14 to shield between the platform 92 and the top of the first end wall 111 of the fixed cover body 11 (as shown in FIG. 10) to prevent formation of a gap through which the sawdust may be blown out, and the dust shielding cover 10 may continue following the circular saw blade mounting seat 91 to sideway swing to an increased angle so as to separate, temporarily, from the contact block 123 of the movable shield plate 12 (as shown in FIG. 10). During a course that the circular saw blade mounting seat 91 drives the circular saw blade 93 to get back to the vertical condition, the inside surface of the second lateral wall 113 becomes pressing against the contact block 123 of the movable shield plate 12 to have the contact flange 121 of the movable shield plate 12 returned to the horizontal condition.

Thus, in addition to effectively blocking sawdust in the condition that the circular saw blade is set vertical, the present invention is also effective in preventing formation of a gap by means of the movable shield plate biased by the spring force when the circular saw blade is set inclined so as to prevent sawdust from being blown out.

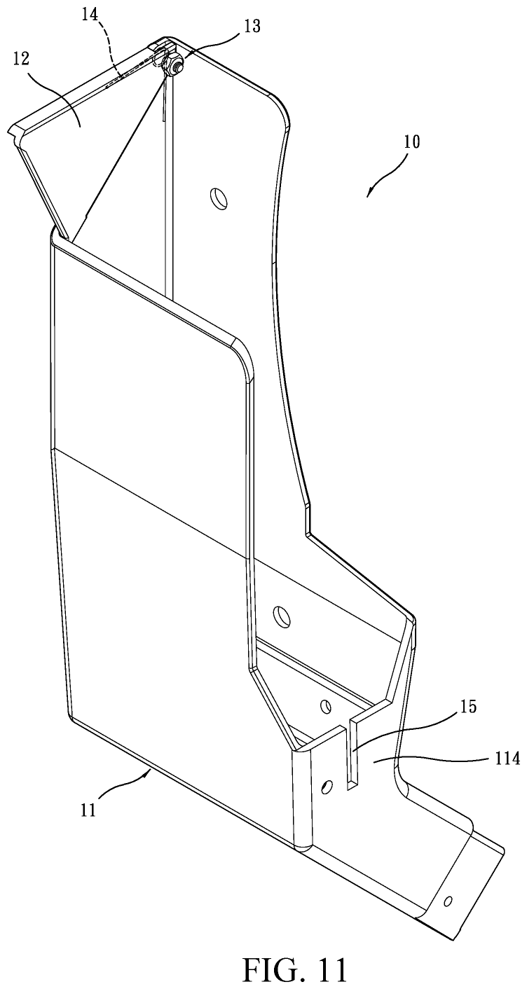

Further, referring to FIG. 11, the present invention may include a circular saw blade avoiding notch 15 formed in the second end wall 114 to extend downward from a top edge thereof, through which a large-sized circular saw blade may extend, so that the present invention is made applicable to different sizes of the circular saw blade to thereby enhance the universality of application of the present invention.

I claim:

1. A sawdust discharge guiding device of a carpenter circular saw machine, comprising:
a dust shielding cover, which comprises a fixed cover body, a movable shield plate, a pivot assembly, and a torsion spring, wherein the fixed cover body comprises a first end wall, a first lateral wall having one side perpendicularly connected to one side of the first end wall, a second lateral wall having one side connected to an opposite side of the first end wall, a second end wall connected between an opposite side of the first lateral wall and an opposite side of the second lateral wall, the second end wall having a height lower than a height of the first end wall, and a dust discharge portion connected among bottoms of the first end wall, the first lateral wall, the second lateral wall and the second end wall, the dust discharge portion and the fixed cover body defining therebetween an angle, which is an obtuse angle, wherein the dust discharge portion comprises a dust discharge opening communicating between inside and outside, a top portion among the first end wall, the first lateral wall, the second lateral wall, and the second end wall being made hollow, a pivot aperture being formed in a top of the first end wall; the movable shield plate comprises a pivot through-hole; the pivot assembly penetrates through and pivotally connects between the pivot aperture of the fixed cover body and the pivot through-hole of the movable shield plate, so that the movable shield plate is rotatable about an axis defined by the pivot assembly; the torsion spring comprises a middle portion through which the pivot assembly penetrates and has one end supported on the first lateral wall of the fixed cover body and an opposite end supported on the movable shield plate, such that the torsion spring provides a preloading spring force to the movable shield plate for upward rotation.

2. The sawdust discharge guiding device of a carpenter circular saw machine according to claim 1, wherein the first end wall is provided, on the top thereof, with a lug at a location adjacent to the first lateral wall, and the pivot aperture is formed in the lug.

3. The sawdust discharge guiding device of a carpenter circular saw machine according to claim 1, wherein the movable shield plate comprises a triangular plate, and the pivot through-hole is formed in one of corners of the movable shield plate.

4. The sawdust discharge guiding device of a carpenter circular saw machine according to claim 1, wherein one side of the movable shield plate is protruded to form a contact flange, and the torsion spring is supported on the contact flange.

5. The sawdust discharge guiding device of a carpenter circular saw machine according to claim 1, wherein the pivot assembly comprises a bolt, a washer, and a nut, the bolt penetrating through the pivot aperture of the fixed cover body, the pivot through-hole of the movable shield plate, and the washer, and the nut and the bolt are screwed to each other.

6. The sawdust discharge guiding device of a carpenter circular saw machine according to claim 1, further comprising a dust discharge tube, which has one end connected to the dust discharge portion of the fixed cover body of the dust shielding cover, so that the dust discharge tube is in communication with an interior of the dust shielding cover, and the dust discharge tube is twistable for deformation as being acted upon by a force.

7. The sawdust discharge guiding device of a carpenter circular saw machine according to claim 1, wherein a circular saw blade avoiding notch is formed in a middle top of the second end wall to extend downward therefrom.

8. The sawdust discharge guiding device of a carpenter circular saw machine according to claim 1, wherein the movable shield plate comprises a triangle plate having a corner that is protruded to form a contact block.
